(19) United States
(12) Patent Application Publication
(10) Pub. No.: US 2026/0113358 A1
(43) Pub. Date: Apr. 23, 2026

(54) SYSTEM AND METHOD FOR ARTIFICIAL INTELLIGENCE-DRIVEN MULTI-CLOUD SECURITY GOVERNANCE AND AUTOMATED COMPLIANCE ENFORCEMENT

(71) Applicant: SANTOSH DATTA BOMPALLY, Mckinney, TX (US)

(72) Inventor: SANTOSH DATTA BOMPALLY, Mckinney, TX (US)

(21) Appl. No.: 19/428,370

(22) Filed: Dec. 22, 2025

(51) Int. Cl. H04L 9/40; G06N 3/098; G06N 5/02

(52) U.S. Cl. CPC H04L 63/20; G06N 3/098; G06N 5/02; H04L 63/1425; H04L 63/1433; H04L 63/1441

(57) ABSTRACT

A system and method for method for managing security governance and enforcing compliance across a plurality of cloud environments using an artificial intelligence model is disclosed. The method includes receiving, from the plurality of cloud environments, data indicative of one or more configurations, one or more operations, and one or more security parameters. The method includes generating a unified representation of a multi-cloud environment. The method includes detecting one or more deviations, one or more anomalies, and one or more non-compliance conditions. The method includes determining one or more governance actions. The method includes executing, through one or more control interfaces, at least a portion of the determined one or more governance actions across the plurality of cloud environments. The method includes updating one or more of one or more models, one or more policies, and one or more decision parameters.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to field of cloud computing security and governance. More particularly, to systems and methods for artificial intelligence-driven multi-cloud security governance and automated compliance enforcement.

### BACKGROUND OF THE INVENTION

The increasing adoption of multi-cloud architectures where enterprises utilize services from multiple public, private, or hybrid cloud providers has introduced significant complexity in maintaining consistent security governance and regulatory compliance. Each cloud platform exposes distinct management interfaces, policy formats, and security controls, leading to fragmented visibility and inconsistent enforcement across environments.

Conventional approaches to cloud security management typically rely on manual rule configuration, static compliance assessments, and siloed monitoring tools specific to individual cloud vendors. These approaches are reactive in nature, often detecting policy violations only after they occur, and lack mechanisms for continuous or coordinated remediation across different cloud platforms. Moreover, heterogeneous policy structures and data representations make it difficult to correlate security events or compliance deviations in a unified manner.

Existing solutions also fail to incorporate machine-driven intelligence for adaptive decision-making. They generally do not leverage artificial intelligence (AI) or machine learning (ML) to analyze cross-cloud patterns, predict potential non-compliance conditions, or automatically enforce corrective actions through standardized interfaces. Consequently, enterprises face challenges in achieving consistent, scalable, and auditable governance across diverse cloud ecosystems.

Therefore, there is need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for managing security governance and enforcing compliance across a plurality of cloud environments using an artificial intelligence model is disclosed. The method includes receiving, from the plurality of cloud environments, data indicative of one or more configurations, one or more operations, and one or more security parameters associated with a plurality of cloud resources. Further, the method includes generating a unified representation of a multi-cloud environment. Furthermore, the method includes detecting one or more deviations, one or more anomalies, and one or more non-compliance conditions with respect to one or more security or compliance policies. In addition, the method includes determining one or more governance actions based on the detected one or more deviations, the one or more anomalies, and the one or more non-compliance conditions, and the one or more non-compliance conditions. In response to determining the one or more governance actions, the method includes executing, through one or more control interfaces, at least a portion of the determined one or more governance actions across the plurality of cloud environments. The method includes updating one or more of one or more models, one or more policies, and one or more decision parameters based on outcomes of the initiated actions.

In accordance with another embodiment of the present disclosure, a system for managing security governance and enforcing compliance across a plurality of cloud environments using an artificial intelligence model is disclosed. The system includes a memory, at least one processor operatively coupled to the memory. The at least one processor is configured to receive, from the plurality of cloud environments, data indicative of one or more configurations, one or more operations, and one or more security parameters associated with a plurality of cloud resources. The at least one processor is configured to generate a unified representation of a multi-cloud environment. The at least one processor is configured to detect one or more deviations, one or more anomalies, and one or more non-compliance conditions with respect to one or more security or compliance policies. The at least one processor is configured to determine one or more governance actions based on the detected one or more deviations, the one or more anomalies, and the one or more non-compliance conditions, and the one or more non-compliance conditions. In response to determining the one or more governance actions, the at least one processor is configured to execute, through one or more control interfaces, at least a portion of the determined one or more governance actions across the plurality of cloud environments. The one or more control interfaces comprise an intent-based orchestration layer configured to translate high-level governance intents into executable enforcement instructions. The at least one processor is configured to update one or more of one or more models, policies, and one or more decision parameters based on outcomes of the initiated actions.

In accordance with another embodiment of the present disclosure, a non-transitory computer-readable medium storing instructions that, when executed, cause a processor to receive, from the plurality of cloud environments, data indicative of one or more configurations, one or more operations, and one or more security parameters associated with a plurality of cloud resources. The processor is configured to generate a unified representation of a multi-cloud environment. The processor is configured to detect one or more deviations, one or more anomalies, and one or more non-compliance conditions with respect to one or more security or compliance policies. The processor is configured to determine one or more governance actions based on the detected one or more deviations, the one or more anomalies, and the one or more non-compliance conditions, and the one or more non-compliance conditions. In response to determining the one or more governance actions, the processor is configured to execute, through one or more control interfaces, at least a portion of the determined one or more governance actions across the plurality of cloud environments. The processor is configured to update one or more of one or more models, one or more policies, and one or more decision parameters based on outcomes of the initiated actions.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram depicting an exemplary environment of distributed cloud nodes associated with a system in distributed cloud environments, in accordance with an embodiment of the present disclosure;

FIG. 2 is a block diagram depicting a system for updating the one or more optimization policies in the distributed cloud environments, in accordance with an embodiment of the present disclosure; and

FIG. 3 is a process flow diagram depicting an exemplary method for updating the one or more optimization policies in the distributed cloud environments, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

An environment and various implementations for a technological framework capable of autonomously analyzing multi-cloud data, detecting deviations or anomalies relative to predefined security or compliance policies, and dynamically executing governance actions through unified, intelligent control mechanisms. The present invention addresses challenges by providing an AI-driven multi-cloud security governance and automated compliance enforcement system and method that operates across environments and continuously refines policy models and decision parameters.

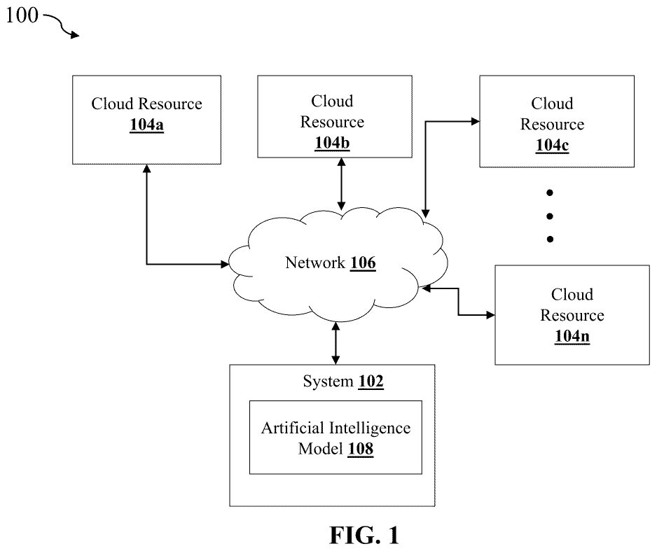

The environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 is a block diagram 100 depicting an environment FIG. 1 of a system 102 for managing security governance and enforcing compliance across a plurality of cloud environments using an artificial intelligence model 108, in accordance with an embodiment of the present disclosure. The system 102 may be configured to receive data from the cloud environments. The data may indicative of one or more configurations, one or more operations, and one or more security parameters associated with a plurality of cloud resources 104a, 104b . . . 104n.

In an embodiment, the plurality of cloud environments may refer to a plurality of distributed computing infrastructures or platforms that provide on-demand access to computing resources, storage, applications, and services through programmable interfaces or network-based delivery models.

Each of the plurality of cloud environments may be operated by a distinct cloud service provider and may expose proprietary resource management interfaces, data formats, and policy enforcement mechanisms. The plurality of cloud environments may include, but are not limited to, public clouds, private clouds, hybrid clouds, community clouds, and the like.

For example, a public cloud environment may include infrastructure and services made available over a shared network, hosted and maintained by third-party providers. Examples include, but are not limited to, infrastructure-as-a-service (IaaS), platform-as-a-service (PaaS), and software-as-a-service (SaaS) offerings. A private cloud environment may may include a dedicated infrastructure managed either on-premises or within a virtual private segment of a public cloud, offering enhanced control, customization, and security isolation.

A hybrid cloud environment may include a combination of public and private clouds integrated through secure connectivity or orchestration layers, thereby enabling dynamic workload distribution and policy synchronization across deployment boundaries. A community or sector-specific cloud environment may be designed for entities with shared compliance requirements, operational standards, or regulatory obligations.

In one or more embodiments, each of the plurality of cloud environments may include a plurality of computing resources such as virtual machines, containers, storage instances, databases, applications, microservices, and network components. These resources may be associated with metadata parameters including access control policies, configuration attributes, audit trails, and operational telemetry data.

The plurality of cloud environments collectively form a multi-cloud ecosystem, from which the system of the present invention receives heterogeneous data streams through respective data ingestion interfaces or Application Programming Interface (API) connectors. The data may include configuration states, activity logs, event metrics, and compliance indicators representing the operational and security status of resources within each environment.

In an embodiment, a unified representation of a multi-cloud environment may be generated based on the received data. The unified representation may include a dynamic compliance knowledge graph that semantically interrelates cloud resources, configurations, policy rules, and historical enforcement outcomes. The system 102 may be configured to detect one or more deviations, one or more anomalies, and one or more non-compliance conditions with respect to one or more security or compliance policies.

The one or more deviations may include any deterministic difference between the current configuration or operational state of a resource and a predefined security or compliance requirement. Examples include unauthorized parameter changes, disabled monitoring controls, or discrepancies between declared and actual network configurations.

The one or more anomalies may include any statistically or behaviorally irregular activity detected across cloud resources, such as abnormal access patterns, unusual network flows, unexpected privilege escalation events, or time-varying deviations from learned behavioral baselines. The anomaly detection may involve temporal pattern analysis, correlation across multiple cloud environments, or clustering of resource behaviors.

The one or more non-compliance conditions may include any instance where a cloud resource or policy setting fails to satisfy a requirement defined under one or more security frameworks, regulatory standards, tenant-specific governance rules, or organization-defined compliance checklists. The one or more non-compliance conditions may be identified by evaluating rules encoded in the unified representation, comparing control states to mandated configurations, or applying compliance mappings.

In one embodiment, the detection process may incorporate cross-cloud correlation, wherein indicators or events originating from distinct cloud environments are jointly analyzed to identify distributed or multi-step non-compliant behaviors that are not detectable when environments are evaluated independently. In another embodiment, the one or more deviations may include temporal deviation analysis, where event sequences, configuration drift patterns, or multi-time-interval trends are examined to detect gradual divergence from compliance norms.

In an embodiment, the system 102 may be configured to determine one or more governance actions based on the detected one or more deviations, the one or more anomalies, and the one or more non-compliance conditions, and the one or more non-compliance conditions.

The one or more governance actions may include evaluating the one or more deviations, the one or more anomalies, and the one or more non-compliance conditions identified during the detection phase and selecting one or more corrective, preventive, or enforcement operations suitable for addressing the identified condition within one or more cloud environments.

In one or more embodiments, the determination includes mapping the detected condition to a corresponding policy clause or remediation rule defined in the unified representation. Further, the system 102 may be configured to identify a set of candidate governance actions applicable to the resource type, policy domain, and environment in which the condition occurred. The system 102 may be configured to evaluate constraints or dependencies associated with the resource, such as upstream/downstream service interactions, tenant-specific configurations, execution permissions, or environment-specific API limitations.

In an embodiment, the system 102 may be configured to select at least one governance action based on the applicability of the action to the detected condition. The governance actions may include, by way of example, modifying configuration parameters, updating policy settings, adjusting access control attributes, performing configuration rollback, isolating a resource, triggering security controls, generating compliance notifications, or initiating a verification or audit routine. In some embodiments, the determination may involve ranking candidate actions based on one or more internal metrics, including rule precedence, historical action outcomes, environment context, or the relative significance of the detected condition.

In response to determining the one or more governance actions, the system 102 may be configured to execute through one or more control interfaces, at least a portion of the determined one or more governance actions across the plurality of cloud environments.

The one or more control interfaces may include cloud-native application programming interfaces (APIs) provided by each cloud service platform for resource management, configuration updates, access control modifications, and security operations. Further, the one or more control interfaces may include agent-based enforcement mechanisms. the lightweight software agents may be deployed within cloud environments receive and execute enforcement directives.

The one or more control interfaces may include infrastructure-as-code (IaC) interfaces enabling updates to declarative configuration templates or state definitions. The one or more control interfaces may include policy enforcement gateways that intercept and apply policy modifications to network, identity, or workload configurations. In an embodiment, executing the one or more governance actions may include serializing the action into an execution instruction set, identifying the target environment and resource, and invoking the corresponding cloud-specific control interface with appropriate authentication credentials and execution parameters. The instruction set may include details such as the operation type, the resource identifier, configuration values to be modified, rollback parameters, or verification checks to be performed after execution.

Further, the system 102 may be configured to update one or more of one or more models, one or more policies, and one or more decision parameters based on outcomes of the initiated actions. The one or more of one or more models, the one or more policies, and the one or more decision parameters may include modify of parameters of one or more artificial intelligence models responsible for deviation detection, anomaly identification, or governance-action selection. The updates may involve adjusting model weights, incorporating new samples or feedback into the training dataset, modifying clustering boundaries, refining anomaly scoring functions, or updating learned behavioral baselines to reflect new operational patterns.

According to FIG. 1, the exemplary environment 100 includes the plurality of cloud resources 104a, 104b . . 104n may be communicated through a network 106. The network 106 may include an internet. The network 106 may be rapidly emerging as a preferred system for distributing and exchanging data. The network 106 may include a cellular network, a public land mobile network (PLMN), a second generation (2G) network, a third generation (3G) network, a fourth generation (4G) network (e.g., a long-term evolution (LTE) network), a fifth generation (5G) network, and/or another network. Additionally, or alternatively, the network 106 may include a wide area network (WAN), a metropolitan network (MAN), a telephone network (e.g., the Public Switched Telephone Network (PSTN)), an ad hoc network, an intranet, an Internet, a fiber optic-based network, and/or a combination of these or other types of networks.

The system 102 may include the artificial intelligence model 108. The artificial intelligence model 108 may include, but is not limited to, a machine learning model, a deep learning model, a rule-based inference engine, or a reinforcement learning framework configured to learn from historical governance and compliance data.

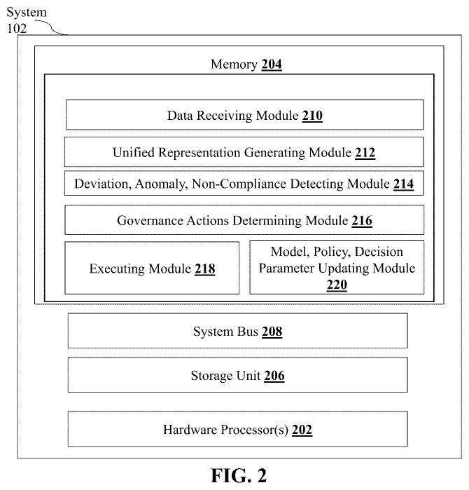

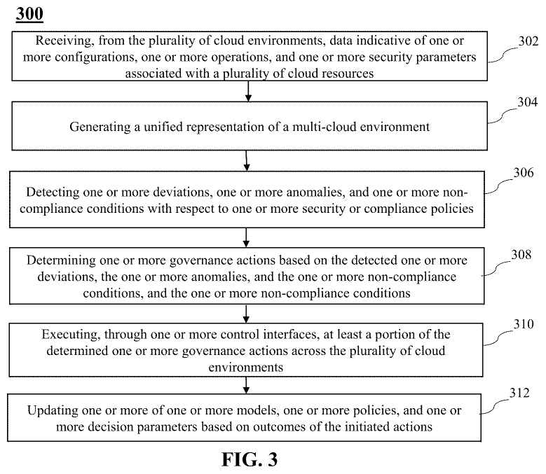

In an embodiment, the system 102 may be implemented within the each of the plurality of cloud resources 104a, 104b . . . 104n. In another embodiment, the system 102 may be externally connected to the plurality of cloud resources 104a, 104b . . 104n. Yet in another embodiment, some part of the system 102 may be implanted within the each of the plurality of cloud resources 104a, 104b . . 104n and remaining part of the system 102 may be externally connected to the each of the plurality of cloud resources 104a, 104b . . 104n. The system 102 has been further detailed with reference to FIG. 2 and FIG. 3.

FIG. 2 is a block diagram 200 depicting the system 102 for managing the security governance and enforcing compliance across the plurality of cloud environments, in accordance with an embodiment of the present disclosure. According to FIG. 2, the system 102 may include one or more hardware processors 202, a memory 204 and a storage unit 206. The one or more hardware processors 202, the memory 204 and the storage unit 206 may be communicatively coupled through a system bus 208 or any similar mechanism. The memory 204 may include a data receiving module 210, a unified representation generating module 212, a deviation, anomaly, non-compliance detecting module 214, a governance actions determining module 216, an executing module 218, and a model, policy, decision parameter updating module 220.

The data receiving module 210 may be configured to receive the data from the plurality of cloud environments associated with the multi-cloud infrastructure. In one or more embodiments, the data receiving module 210 may include one or more ingestion interfaces, connectors, or API integration components that interact with cloud-specific management endpoints, telemetry streams, and configuration repositories. The data received by the data receiving module may include configuration data of the plurality of cloud resources 104a, 104b . . 104n, access control metadata, security and compliance policy definitions, operational telemetry such as logs, metrics, and events, and resource state information from virtual machines, containers, storage systems, network components, and applications.

The data receiving module 210 may further perform pre-processing operations such as authentication, data filtering, timestamp normalization, batching, or deduplication prior to forwarding the data to subsequent modules.

In some embodiments, the data receiving module 210 may support asynchronous, event-driven, or stream-based ingestion to accommodate heterogeneous cloud service provider mechanisms.

Security exception handling should be a part of posture management. When exceptions are approved and implemented, continuous or residual monitoring must be in place to ensure the exception remains within its defined scope. This helps validate that no unintended drift occurs.

Security exception handling should be an integral part of posture management. When exceptions are approved and implemented, continuous or residual monitoring must be in place to ensure the exception remains within its defined scope. This helps validate that no unintended drift occurs over time, reducing the risk of new or expanded security exposures.

The unified representation generating module 212 may be configured to generate a normalized and consolidated representation of the multi-cloud environment based on the heterogeneous data received from the data receiving module 210. In one or more embodiments, the unified representation generating module 212 may be configured to perform normalization of cloud-specific formats into a standardized schema, mapping of resource identifiers, configuration attributes, and policy structures into unified data constructs, correlation of related information across different cloud environments, and organization of resource, policy, and telemetry data into a uniform governance model.

The unified representation may include the plurality of cloud resources 104a, 104b . . 104n and attributes, access control settings and identity relationships, the one or more security and compliance policies, dependency graphs between services or workloads, telemetry observations, and historical event and configuration states. The unified representation generating module 212 may be configured to implement one or more parsing engines, schema transformation pipelines, semantic mapping components, or metadata consolidation routines.

In some embodiments, the unified representation generating module 212 may be configured to produce a representation stored in a graph-based structure, policy knowledge base, or multi-dimensional dataset to support downstream detection, analysis, and governance-action determination.

In an embodiment, the deviation, anomaly, non-compliance detecting module 214 may be configured to correlate security telemetry across the plurality of cloud environments using a federated learning mode based on the generated unified representation. Further, the deviation, anomaly, non-compliance detecting module 214 may be configured to detect the one or more deviations, the one or more anomalies, and the one or more non-compliance conditions with respect to the one or more security or compliance policies based on the correlated security telemetry across the plurality of cloud environments.

In an embodiment, the governance actions determining module 216 may be configured to generate a compliance reasoning graph linking each detected deviation to an applicable policy clause, remediation rule, and impact metric based on the one or more detected deviations, the one or more anomalies, and the one or more non-compliance conditions, and the one or more non-compliance conditions. Further, the governance actions determining module 216 may be configured to determine the one or more governance actions based on the generated compliance reasoning graph.

The compliance reasoning graph may refer to a structured, machine-interpretable graph representation generated and utilized by a governance system to model relationships among the plurality of cloud resources 104a, 104b . . 104n, policy requirements, detected conditions, and applicable remediation actions.

In accordance with an embodiment, the compliance reasoning graph may include a set of nodes and edges that collectively encode the compliance context of the multi-cloud environment. In one or more embodiments, the set of nodes of the compliance reasoning graph represent the plurality of cloud resources 104a, 104b . . 104n or resource groups, configuration attributes or parameter states, identity objects or access control elements, security or compliance policy clauses, detected deviations, anomalies, or non-compliance conditions, remediation rules or governance-action templates, and historical enforcement outcomes. Each node may be associated with metadata such as resource identifiers, policy identifiers, timestamps, severity indicators, or environmental attributes.

Examples include mappings between a resource and the policy requirements applicable to that resource, links between a detected deviation and the policy clause it violates, relationships indicating dependencies between cloud services or components, associations between a non-compliance condition and candidate governance actions, and edges representing the outcome of previously executed actions.

The edges may be directional or bidirectional and may encode relationship types such as “violates,” “requires,” “derived from,” “applicable to,” “impacts,” or “remediated by. ” The compliance reasoning graph allows the system to organize heterogeneous compliance-relevant information into a unified relational structure. The compliance reasoning graph may determine the contextual impact of deviations or anomalies. The compliance reasoning graph may identify policy clauses associated with a detected condition. The compliance reasoning graph may identify corresponding remediation or governance actions. The compliance reasoning graph may support selection of actions by traversing or querying the graph. The compliance reasoning graph may also be dynamically updated as new compliance data, resource states, or enforcement outcomes are observed, thereby reflecting the evolving multi-cloud environment.

The compliance reasoning graph may be stored using one or more of a graph database, a semantic knowledge graph engine, a structured relational mapping layer, or an in-memory graph representation. In some embodiments, the compliance reasoning graph may be generated by the governance actions determining module 216 that derives nodes and edges from unified representation and detection outputs.

In response to determining the one or more governance actions, the executing module 218 may be configured to execute, through the one or more control interfaces, at least a portion of the determined one or more governance actions across the plurality of cloud environments. In an embodiment, the executing module 218 may be configured to selectively trigger one or more adaptive enforcement workflows that modify execution logic in real time based on observed environmental constraints or inter-cloud dependency states. Further, the executing module 218 may be configured to execute, through the one or more control interfaces, at least the portion of the determined one or more governance actions across the plurality of cloud environments.

In an embodiment, the model, policy, decision parameter updating module 220 may be configured to context-sensitive retraining of the artificial intelligence model 108 by incorporating successful and failed enforcement outcomes. Further, the model, policy, decision parameter updating module 220 may be configured to update one or more of the one or more models, the one or more policies, and the one or more decision parameters.

In an embodiment, the model, policy, decision parameter updating module 220 may be configured to update one or more of the one or more models, the one or more policies, and the one or more decision parameters comprises reinforcement learning-based optimization. The artificial intelligence model may dynamically adjust policy enforcement strategies based on feedback from prior enforcement outcomes across the plurality of cloud environments.

In accordance with an embodiment, the system 102 may be configured to implement security exception handling as an integral component of a multi-cloud security posture management framework. A security exception may indicate an authorized deviation from the one or more security or compliance policies. For example, a cloud resource, configuration, or operational behavior is permitted to temporarily or conditionally operate outside a standard policy constraint.

Further, the system 102 may provide a structured mechanism to register, approve, implement, and continuously monitor security exceptions across the plurality of cloud environments. In an embodiment, the security exception may be defined by a set of parameters. The set of parameters may include, but are not limited to, an affected cloud resource or resource group, a specific policy clause or control being excepted, a permitted deviation range or condition, a temporal validity period, one or more contextual constraints, including environment, identity, or workload characteristics, and the like.

Upon approval of the security exception, the set of parameters may be incorporated into the system 102 and link to the corresponding policy definitions within the compliance reasoning graph. The security exception may be represented as a distinct node or attribute that modifies policy evaluation logic without permanently altering the underlying policy definition.

In an embodiment, during posture analysis and deviation detection, the artificial intelligence model 108 may evaluate cloud resource states. Further, the system 102 may be configured to apply continuous or residual monitoring to the plurality of cloud resources 104a, 104b . . 104n operating under an approved security exception. The monitoring may include observing configuration changes, access patterns, telemetry trends, and environment context. The residual monitoring may include periodic re-evaluation of exception-associated resources, temporal analysis to detect gradual configuration drift, cross-cloud correlation to identify indirect impacts of the exception on dependent resources, and comparison of real-time behavior.

In an embodiment, the system 102 may generates exception-specific behavioral profiles, enabling the AI model 108 to detect the one or more deviations that may not violate the one or more security or compliance policies but exceed the permitted exception conditions. If residual monitoring detects that an exception has expanded beyond the permitted exception conditions, exceeded temporal validity, or resulted in unintended policy interactions, the system 102 may identify a condition as an exception drift event.

The system 102 may ensure that security exception handling is not treated as an external or manual process, but rather as a first-class element of security posture management. The system 102 may embed exception definition, monitoring, and enforcement, the system 102 may maintain continuous visibility and control over authorized deviations across the plurality of cloud environments.

FIG. 3 is a process flow diagram 300 illustrating an exemplary method for managing security governance and enforcing compliance across the plurality of cloud environments, in accordance with an embodiment of the present disclosure.

At step 302, the method 300 may include receiving, from the plurality of cloud environments, the data indicative of the one or more configurations, the one or more operations, and the one or more security parameters associated with the plurality of cloud resources 104a, 104b . . 104n.

At step 304, the method 300 may include generating the unified representation of a multi-cloud environment.

At step 306, the method 300 may include detecting the one or more deviations, the one or more anomalies, and the one or more non-compliance conditions with respect to the one or more security or compliance policies.

At step 308, the method 300 may include determining the one or more governance actions based on the detected one or more deviations, the one or more anomalies, and the one or more non-compliance conditions, and the one or more non-compliance conditions.

In response to determining the one or more governance actions, at step 310, the method 300 may include executing, through the one or more control interfaces, at least the portion of the determined one or more governance actions across the plurality of cloud environments.

At step 312, the method 300 may include updating the one or more of one or more models, the one or more policies, and the one or more decision parameters based on the outcomes of the initiated actions.

In an embodiment, for detecting the one or more deviations, the one or more anomalies, and the one or more non-compliance conditions, the method 300 may include correlating the security telemetry across the plurality of cloud environments using the federated learning mode based on the generated unified representation. The method 300 may include detecting the one or more deviations, the one or more anomalies, and the one or more non-compliance conditions with respect to one or more security or compliance policies based on the correlated security telemetry across the plurality of cloud environments.

In an embodiment, for determining the one or more governance actions, the method 300 may include generating the compliance reasoning graph linking each detected deviation to an applicable policy clause, remediation rule, and impact metric based on the detected one or more deviations, the one or more anomalies, and the one or more non-compliance conditions, and the one or more non-compliance conditions. The method 300 may include determining the one or more governance actions based on the generated compliance reasoning graph.

In an embodiment, for executing the determined governance actions, the method 300 may include selectively triggering one or more adaptive enforcement workflows that modify execution logic in real time based on observed environmental constraints or inter-cloud dependency states. The method 300 may include executing, through the one or more control interfaces, at least the portion of the determined one or more governance actions across the plurality of cloud environments.

The method 300 may include predicting the future compliance degradation or security drift using the temporal prediction model trained on the historical remediation outcomes and evolving configuration changes across the plurality of cloud environments.

In an embodiment, for updating the one or more of one or more models, the one or more policies, and the one or more decision parameters, the method 300 may include context-sensitive retraining of the artificial intelligence model by incorporating successful and failed enforcement outcomes. The method 300 may include updating one or more of the one or more models, the one or more policies, and the one or more decision parameters.

The unified representation further may include the dynamic compliance knowledge graph that semantically interrelates cloud resources, configurations, policy rules, and historical enforcement outcomes.

In an embodiment, for determining the one or more governance actions, the method 300 may include determining the multidimensional governance score indicating the compliance confidence, the remediation priority, and the potential operational impact. The multidimensional governance score may be used to drive autonomous action sequencing.

In an embodiment, the one or more control interfaces may include an intent-based orchestration layer configured to translate high-level governance intents into executable enforcement instructions. In an embodiment, the method 300 may include updating the one or more of the one or more models, the one or more policies, and the one or more decision parameters. In an embodiment, the method 300 may include the reinforcement learning-based optimization. The artificial intelligence model 108 may be configured to dynamically adjust the policy enforcement strategies based on feedback from prior enforcement outcomes across heterogeneous cloud environments.

The methods may be implemented in any suitable hardware, software, firmware, or combination thereof.

Thus, various embodiments of the present invention provide several technical advantages over conventional cloud security and compliance management systems.
The present invention generates a consolidated and normalized representation of heterogeneous cloud environments, enabling consistent analysis and enforcement across cloud providers that expose incompatible formats, APIs, and policy structures.
The present invention employs artificial intelligence models for deviation detection, anomaly identification, and non-compliance evaluation, the system is capable of identifying complex or cross-environment conditions that are not detectable through isolated or rule-based tools.
The present invention determines governance actions based on resource context, policy mappings, dependency relationships, and detection metadata, providing a more precise and technically informed decision-making process compared to manual or static remediation workflows.
Execution of governance actions through cloud-native interfaces, orchestration systems, or agent-based mechanisms enables automated enforcement across heterogeneous cloud infrastructures without requiring provider-specific reimplementation.
The present invention updates artificial intelligence models, policy mappings, and decision parameters using feedback obtained from executed governance actions, allowing the system to refine detection accuracy and enforcement behavior over time.
The ability to correlate telemetry, configuration data, and compliance indicators from multiple cloud environments enables the system to identify distributed conditions, multi-step deviations, and policy violations that are not observable when environments are analyzed independently.
The compliance reasoning graph provides a structured, machine-interpretable representation of relationships between resources, policies, detected conditions, and remediation actions, enabling efficient graph traversal, contextual analysis, and explainable governance decisions.
Through automated analysis, enforcement, and learning-driven updates, the invention reduces manual rule configuration, repetitive remediation tasks, and cross-cloud monitoring activities, improving operational efficiency and reducing configuration errors.
The modular architecture of the system, including discrete data ingestion, representation, detection, reasoning, and enforcement components, allows the invention to scale to large, distributed, and dynamically changing multi-cloud infrastructures.

Examples of the techniques and system described herein include, but are not limited to, the following enumerated embodiments:
i. A method for managing security governance and enforcing compliance across a plurality of cloud environments using an artificial intelligence model, the method includes,
   receiving, from the plurality of cloud environments, data indicative of one or more configurations, one or more operations, and one or more security parameters associated with a plurality of cloud resources;
   generating a unified representation of a multi-cloud environment;
   detecting one or more deviations, one or more anomalies, and one or more non-compliance conditions with respect to one or more security or compliance policies;
   determining one or more governance actions based on the detected one or more deviations, the one or more anomalies, and the one or more non-compliance conditions, and the one or more non-compliance conditions;
   in response to determining the one or more governance actions, executing, through one or more control interfaces, at least a portion of the determined one or more governance actions across the plurality of cloud environments; and
   updating one or more of one or more models, one or more policies, and one or more decision parameters based on outcomes of the initiated actions.
ii. The method as described in paragraph [i], wherein detecting the one or more deviations, the one or more anomalies, and the one or more non-compliance conditions includes,
   correlating security telemetry across the plurality of cloud environments using a federated learning mode based on the generated unified representation; and
   detecting the one or more deviations, the one or more anomalies, and the one or more non-compliance conditions with respect to one or more security or compliance policies based on the correlated security telemetry across the plurality of cloud environments.
iii. The method as described in paragraphs [i]-[ii], wherein determining the one or more governance actions includes,
   generating a compliance reasoning graph linking each detected deviation to an applicable policy clause, remediation rule, and impact metric based on the detected one or more deviations, the one or more anomalies, and the one or more non-compliance conditions, and the one or more non-compliance conditions; and
   determining the one or more governance actions based on the generated compliance reasoning graph.
iv. The method as described in paragraphs [i]-[iii], wherein executing the determined governance actions includes,
   selectively triggering one or more adaptive enforcement workflows that modify execution logic in real time based on observed environmental constraints or inter-cloud dependency states; and
   executing, through one or more control interfaces, at least a portion of the determined one or more governance actions across the plurality of cloud environments.
v. The method as described in paragraphs [i]-[iv], predicting future compliance degradation or security drift using a temporal prediction model trained on historical remediation outcomes and evolving configuration changes across the plurality of cloud environments.
vi. The method as described in paragraphs [i]-[v], wherein updating the one or more of one or more models, the one or more policies, and the one or more decision parameters includes,
   context-sensitive retraining of the artificial intelligence model by incorporating successful and failed enforcement outcomes; and
   updating one or more of the one or more models, the one or more policies, and the one or more decision parameters.
vii. The method as described in paragraphs [i]-[vi], wherein the unified representation further comprises a dynamic compliance knowledge graph that semantically interrelates cloud resources, configurations, policy rules, and historical enforcement outcomes.
viii. The method as described in paragraphs [i]-[vii], wherein determining the one or more governance actions further includes,
   determining a multidimensional governance score indicating a compliance confidence, a remediation priority, and potential operational impact, wherein the multidimensional governance score is used to drive autonomous action sequencing.
ix. The method as described in paragraphs [i]-[viii], wherein the one or more control interfaces comprise an intent-based orchestration layer configured to translate high-level governance intents into executable enforcement instructions.
x. The method as described in paragraphs [i]-[ix], updating one or more of the one or more models, the one or more policies, and the one or more decision parameters comprises reinforcement learning-based optimization, wherein the artificial intelligence model dynamically adjusts policy enforcement strategies based on feedback from prior enforcement outcomes across heterogeneous cloud environments.
xi. A system for managing security governance and enforcing compliance across a plurality of cloud environments using an artificial intelligence model, the system includes,
   a memory,
   at least one processor operatively coupled to the memory, wherein the at least one processor is configured to:
   receive, from the plurality of cloud environments, data indicative of one or more configurations, one or more operations, and one or more security parameters associated with a plurality of cloud resources;
   generate a unified representation of a multi-cloud environment;
   detect one or more deviations, one or more anomalies, and one or more non-compliance conditions with respect to one or more security or compliance policies;
   determine one or more governance actions based on the detected one or more deviations, the one or more anomalies, and the one or more non-compliance conditions, and the one or more non-compliance conditions;
   in response to determining the one or more governance actions, execute, through one or more control interfaces, at least a portion of the determined one or more governance actions across the plurality of cloud environments, wherein the one or more control interfaces comprise an intent-based orchestration layer configured to translate high-level governance intents into executable enforcement instructions; and
   update one or more of one or more models, policies, and one or more decision parameters based on outcomes of the initiated actions.
xii. The system as described in paragraph [xi], wherein to detect the one or more deviations, the one or more anomalies, and the one or more non-compliance conditions, the at least one processor is configured to:
   correlate security telemetry across the plurality of cloud environments using a federated learning mode based on the generated unified representation; and
   detect the one or more deviations, the one or more anomalies, and the one or more non-compliance conditions with respect to one or more security or compliance policies based on the correlated security telemetry across the plurality of cloud environments.
xiii. The system as described in paragraphs [xi]-[xii], wherein to determine the one or more governance actions, the at least one processor is configured to:
   generate a compliance reasoning graph linking each detected deviation to an applicable policy clause, remediation rule, and impact metric based on the detected one or more deviations, the one or more anomalies, and the one or more non-compliance conditions, and the one or more non-compliance conditions; and
   determine one or more governance actions based on the generated compliance reasoning graph.
xiv. The system as described in paragraphs [xi]-[xiii], wherein to execute the determined governance actions, the at least one processor is configured to:
   selectively trigger one or more adaptive enforcement workflows that modify execution logic in real time based on observed environmental constraints or inter-cloud dependency states; and
   execute, through one or more control interfaces, at least a portion of the determined one or more governance actions across the plurality of cloud environments.
xv. The system as described in paragraphs [xi]-[xiv], wherein the at least one processor is configured to:
   predict future compliance degradation or security drift using a temporal prediction model trained on historical remediation outcomes and evolving configuration changes across the plurality of cloud environments.
xvi. The system as described in paragraphs [x]-[xv], wherein to update the one or more of one or more models, the one or more policies, and the one or more decision parameters, the at least one processor is configured to:
   context-sensitive retrain of the artificial intelligence model by incorporating successful and failed enforcement outcomes; and
   update one or more of one or more models, policies, and one or more decision parameters.
xvii. The system as described in paragraphs [xi]-[xvi], wherein the unified representation further comprises a dynamic compliance knowledge graph that semantically interrelates cloud resources, configurations, policy rules, and historical enforcement outcomes.
xviii. The system as described in paragraphs [xi]-[xvii], wherein to determine the one or more governance actions, the at least one processor is configured to:
   determining a multidimensional governance score indicating a compliance confidence, a remediation priority, and potential operational impact, wherein the multidimensional governance score is used to drive autonomous action sequencing.
xix. The system as described in paragraphs [xi]-[xviii], wherein updating one or more of the models, policies, and decision parameters comprises reinforcement learning-based optimization, wherein the artificial intelligence model dynamically adjusts policy enforcement strategies based on feedback from prior enforcement outcomes across heterogeneous cloud environments.
xx. A non-transitory computer-readable medium storing instructions that, when executed, cause a processor to:
   receive, from the plurality of cloud environments, data indicative of one or more configurations, one or more operations, and one or more security parameters associated with a plurality of cloud resources;
   generate a unified representation of a multi-cloud environment;
   detect one or more deviations, one or more anomalies, and one or more non-compliance conditions with respect to one or more security or compliance policies;
   determine one or more governance actions based on the detected one or more deviations, the one or more anomalies, and the one or more non-compliance conditions, and the one or more non-compliance conditions;
   in response to determining the one or more governance actions, execute, through one or more control interfaces, at least a portion of the determined one or more governance actions across the plurality of cloud environments; and
   update one or more of one or more models, one or more policies, and one or more decision parameters based on outcomes of the initiated actions.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the”include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for managing security governance and enforcing compliance across a plurality of cloud environments using an artificial intelligence model, the method comprising:
receiving, from the plurality of cloud environments, data indicative of one or more configurations, one or more operations, and one or more security parameters associated with a plurality of cloud resources;
generating a unified representation of a multi-cloud environment;
detecting one or more deviations, one or more anomalies, and one or more non-compliance conditions with respect to one or more security or compliance policies;
determining one or more governance actions based on the detected one or more deviations, the one or more anomalies, and the one or more non-compliance conditions, and the one or more non-compliance conditions;
in response to determining the one or more governance actions, executing, through one or more control interfaces, at least a portion of the determined one or more governance actions across the plurality of cloud environments; and
updating one or more of one or more models, one or more policies, and one or more decision parameters based on outcomes of the initiated actions.

2. The method of claim 1, wherein detecting the one or more deviations, the one or more anomalies, and the one or more non-compliance conditions comprises:
correlating security telemetry across the plurality of cloud environments using a federated learning mode based on the generated unified representation; and
detecting the one or more deviations, the one or more anomalies, and the one or more non-compliance conditions with respect to one or more security or compliance policies based on the correlated security telemetry across the plurality of cloud environments.

3. The method of claim 1, wherein determining the one or more governance actions comprises:
generating a compliance reasoning graph linking each detected deviation to an applicable policy clause, remediation rule, and impact metric based on the detected one or more deviations, the one or more anomalies, and the one or more non-compliance conditions, and the one or more non-compliance conditions; and
determining one or more governance actions based on the generated compliance reasoning graph.

4. The method of claim 1, wherein executing the determined governance actions comprises:
selectively triggering one or more adaptive enforcement workflows that modify execution logic in real time based on observed environmental constraints or inter-cloud dependency states; and
executing, through one or more control interfaces, at least a portion of the determined one or more governance actions across the plurality of cloud environments.

5. The method of claim 1, further comprising:
predicting future compliance degradation or security drift using a temporal prediction model trained on historical remediation outcomes and evolving configuration changes across the plurality of cloud environments.

6. The method of claim 1, wherein updating the one or more of one or more models, the one or more policies, and the one or more decision parameters comprises:
context-sensitive retraining of the artificial intelligence model by incorporating successful and failed enforcement outcomes; and
updating one or more of the one or more models, the one or more policies, and the one or more decision parameters.

7. The method of claim 1, wherein the unified representation further comprises a dynamic compliance knowledge graph that semantically interrelates cloud resources, configurations, policy rules, and historical enforcement outcomes.

8. The method of claim 1, wherein determining the one or more governance actions further comprises:
determining a multidimensional governance score indicating a compliance confidence, a remediation priority, and potential operational impact, wherein the multidimensional governance score is used to drive autonomous action sequencing.

9. The method of claim 1, wherein the one or more control interfaces comprise an intent-based orchestration layer configured to translate high-level governance intents into executable enforcement instructions.

10. The method of claim 1, further comprising:
updating one or more of the one or more models, the one or more policies, and the one or more decision parameters comprises reinforcement learning-based optimization, wherein the artificial intelligence model dynamically adjusts policy enforcement strategies based on feedback from prior enforcement outcomes across heterogeneous cloud environments.

11. A system for managing security governance and enforcing compliance across a plurality of cloud environments using an artificial intelligence model, the system comprising:
a memory;
at least one processor operatively coupled to the memory, wherein the at least one processor is configured to:
receive, from the plurality of cloud environments, data indicative of one or more configurations, one or more operations, and one or more security parameters associated with a plurality of cloud resources;
generate a unified representation of a multi-cloud environment;
detect one or more deviations, one or more anomalies, and one or more non-compliance conditions with respect to one or more security or compliance policies;
determine one or more governance actions based on the detected one or more deviations, the one or more anomalies, and the one or more non-compliance conditions, and the one or more non-compliance conditions;
in response to determining the one or more governance actions, execute, through one or more control interfaces, at least a portion of the determined one or more governance actions across the plurality of cloud environments, wherein the one or more control interfaces comprise an intent-based orchestration layer configured to translate high-level governance intents into executable enforcement instructions; and
update one or more of one or more models, policies, and one or more decision parameters based on outcomes of the initiated actions.

12. The system of claim 11, wherein to detect the one or more deviations, the one or more anomalies, and the one or more non-compliance conditions, the at least one processor is configured to:
correlate security telemetry across the plurality of cloud environments using a federated learning mode based on the generated unified representation; and
detect the one or more deviations, the one or more anomalies, and the one or more non-compliance conditions with respect to one or more security or compliance policies based on the correlated security telemetry across the plurality of cloud environments.

13. The system of claim 11, wherein to determine the one or more governance actions, the at least one processor is configured to:
generate a compliance reasoning graph linking each detected deviation to an applicable policy clause, remediation rule, and impact metric based on the detected one or more deviations, the one or more anomalies, and the one or more non-compliance conditions, and the one or more non-compliance conditions; and
determine one or more governance actions based on the generated compliance reasoning graph.

14. The system of claim 11, wherein to execute the determined governance actions, the at least one processor is configured to:
selectively trigger one or more adaptive enforcement workflows that modify execution logic in real time based on observed environmental constraints or inter-cloud dependency states; and
execute, through one or more control interfaces, at least a portion of the determined one or more governance actions across the plurality of cloud environments.

15. The system of claim 11, wherein the at least one processor is configured to:
predict future compliance degradation or security drift using a temporal prediction model trained on historical remediation outcomes and evolving configuration changes across the plurality of cloud environments.

16. The system of claim 11, wherein to update the one or more of one or more models, the one or more policies, and the one or more decision parameters, the at least one processor is configured to:
context-sensitive retrain of the artificial intelligence model by incorporating successful and failed enforcement outcomes; and
update one or more of one or more models, policies, and one or more decision parameters.

17. The system of claim 11, wherein the unified representation further comprises a dynamic compliance knowledge graph that semantically interrelates cloud resources, configurations, policy rules, and historical enforcement outcomes.

18. The system of claim 11, wherein to determine the one or more governance actions, the at least one processor is configured to:
determining a multidimensional governance score indicating a compliance confidence, a remediation priority, and potential operational impact, wherein the multidimensional governance score is used to drive autonomous action sequencing.

19. The system of claim 11, wherein updating one or more of the models, policies, and decision parameters comprises reinforcement learning-based optimization, wherein the artificial intelligence model dynamically adjusts policy enforcement strategies based on feedback from prior enforcement outcomes across heterogeneous cloud environments.

20. A non-transitory computer-readable medium storing instructions that, when executed, cause a processor to:
receive, from the plurality of cloud environments, data indicative of one or more configurations, one or more operations, and one or more security parameters associated with a plurality of cloud resources;
generate a unified representation of a multi-cloud environment;
detect one or more deviations, one or more anomalies, and one or more non-compliance conditions with respect to one or more security or compliance policies;
determine one or more governance actions based on the detected one or more deviations, the one or more anomalies, and the one or more non-compliance conditions, and the one or more non-compliance conditions;
in response to determining the one or more governance actions, execute, through one or more control interfaces, at least a portion of the determined one or more governance actions across the plurality of cloud environments; and
update one or more of one or more models, one or more policies, and one or more decision parameters based on outcomes of the initiated actions.
